(19) United States
(12) Patent Application Publication
(10) Pub. No.: US 2012/0300989 A1
(43) Pub. Date: Nov. 29, 2012

(54) IMAGING DEVICE, BIOMETRIC AUTHENTICATION DEVICE, ELECTRONIC EQUIPMENT

(75) Inventor: Yoshiki NAKASHIMA, Suwa-shi (JP)

(73) Assignee: SEIKO EPSON CORPORATION, Tokyo (JP)

(21) Appl. No.: 13/481,399

(22) Filed: May 25, 2012

(30) Foreign Application Priority Data
May 26, 2011 (JP) 2011-117685

(51) Int. Cl. G06K 9/00; H04N 7/18

(52) U.S. Cl. 382/115; 348/77

(57) ABSTRACT

An imaging device that captures a vein pattern of a living body including a lens array having a plurality of microlenses and an imaging element that receives a light converged by the lens array, wherein the plurality of microlenses include a plurality of first microlenses and a plurality of second microlenses that have a focal distance longer than that of the plurality of first microlenses.

### BACKGROUND

1. Technical Field

The present invention relates to an imaging device, a biometric authentication device, and an electronic equipment that includes the imaging device and the biometric authentication device.

2. Related Art

As an example of the imaging device, a personal identification device is known to capture images of the finger blood vessel (vein) pattern.

For example, JP-A-2008-67727 discloses a personal authentication device that captures finger vein images by radiating light having different wavelengths so as to pass though the finger, detects the difference between the captured finger vein images by comparing the captured finger vein images, and verifies whether the captured finger vein images match the finger vein image of the living body. This personal authentication device was developed for the purpose of preventing fraud in authentication such as the use of fake finger or vein pattern attached on the finger of a living body. However, since the captured finger vein image is so-called two-dimensional image, a complex forgery may not be detected. Accordingly, a more advanced personal authentication device, i.e., imaging device is required.

JP-A-2007-328485 provides a personal authentication device that captures finger vein images by radiating near-infrared light toward the inserted finger in two or more directions, and generates an authentication data by combining the finger vein images captured by the near-infrared light in two or more directions. JP-A-2007-328485 describes that the authentication accuracy can be improved.

Further, JP-A-2006-288872 discloses a blood vessel image input device that includes a plurality of refractive-index distributed type lens arrays as a focusing unit positioned between the illuminated finger and imaging elements such as the solid-state imaging elements so that the image of veins that are three-dimensionally distributed inside the finger is obtained. JP-A-2006-288872 describes that the authentication accuracy can be improved and the size and cost of the blood vessel image input device can be reduced.

However, according to JP-A-2007-328485, since the finger vein images in two or more directions are captured, the personal authentication device requires for a light source for illuminating the finger and a camera as an imaging unit to be provided for each of the imaging directions. As a result, it is difficult to reduce the size of the personal authentication device.

Further, in the blood vessel image input device of JP-A-2006-288872, three sets of image capturing mechanisms are provided, each having the refractive-index distributed type lens array and the solid-state imaging element, so as to form the focal points at different positions inside the finger. A transparent guide plate is disposed between the image capturing mechanisms and the finger so that the vein image is obtained by moving the finger along the transparent guide plate. That is, the finger is scanned by moving the finger with respect to the image capturing mechanisms. However, the movement or orientation of the finger may vary for each scan, which causes a problem in that a stable image of vein cannot be obtained.

### SUMMARY

The invention can be embodied as the following embodiments or application examples.

### Application Example 1

According to an application example 1, an imaging device that captures a vein pattern of a living body includes a lens array including a plurality of microlenses that are arranged two dimensionally with respect to a transparent substrate, and imaging elements that receive a light converged by the microlenses, wherein the plurality of microlenses include a plurality of first microlenses and a plurality of second microlenses that have a focal distance longer than that of the plurality of first microlenses. With this configuration, since there is provided the lens array in which the first and second microlenses having different focal distances are arranged two dimensionally, at least two imaging planes are formed inside the living body so that vein patterns can be captured for each of the imaging planes. Accordingly, it is possible to provide the imaging device that is capable of acquiring vein pattern as biological information which enables accurate authentication.

### Application Example 2

In the imaging device according to the application example 1, it is preferable that the first and second microlenses are formed to have different lens diameters and thus have different focal distances, with the second microlens having a lens diameter larger than that of the first microlens. With this configuration, the lens diameter of the second microlens having a longer focal distance is larger than that of the first microlens, thereby effectively converging the light, so that the pattern of veins deep inside the living body can be clearly imaged.

### Application Example 3

In the imaging device according to the application example 1, it is preferable that each of the first microlenses are positioned between each of the second microlenses that are positioned on the transparent substrate in an extending direction of the vein pattern with predetermined intervals. With this configuration, a space on the transparent substrate can be effectively used in positioning the first and second microlenses. That is, a smaller-sized imaging device can be provided.

### Application Example 4

In the imaging device according to the application example 1, it is preferable that the plurality of second microlenses are positioned on the transparent substrate in the extending direction of the vein pattern while being offset from each other in a direction intersecting with the extending direction of the vein pattern. With this configuration, the vein pattern in a more extended area in a two dimensional plane can be captured by effectively using a space on the transparent substrate, when compared with a case where the second microlenses are positioned in the extending direction of the vein pattern in a linear manner.

### Application Example 5

In the imaging device according to the application example 1, it is preferable that an offset amount of the second microlenses in the direction intersecting with the extending direction of the vein pattern is 100 μm or less. With this configuration, since the size of major veins of the finger is approximately 100 μm, it is possible to capture the vein pattern in a more extended area in a two dimensional plane with high accuracy.

### Application Example 6

In the imaging device according to the application example 1, it is preferable that the lens diameter of the first microlens is 20 μm or more and 200 μm or less. With this configuration, the pattern of veins near the surface of the living body can be clearly imaged with high accuracy.

### Application Example 7

In the imaging device according to the application example 1, it is preferable that the lens diameter of the second microlens is 150 μm or more and 500 μm or less. With this configuration, the pattern of veins inside the living body can be clearly imaged with high accuracy.

### Application Example 8

In the imaging device according to the application example 1, the lens diameter of the first microlens is the same as that of the second microlens, and the first and second microlenses may be alternatively positioned on the transparent substrate in the extending direction of the vein pattern.

### Application Example 9

In the imaging device according to the application example 1, the imaging device may include a light shielding member having openings formed at positions between the lens array and the imaging elements on light axes of the first microlenses and the second microlenses, wherein the size of the opening with respect to the first microlens and the size of the opening with respect to the second microlens are different. With this configuration, since the light shielding member that has the openings on the light axes of the respective first microlenses and second microlenses serves as a diaphragm, the effect of stray light can be minimized and the sharp, high contrast image of the vein pattern can be captured.

### Application Example 10

According to an application example 10, a biometric authentication device includes the imaging device according to any of the above application examples, and an authentication execution unit that verifies whether the vein pattern captured by the imaging device matches a pre-registered vein pattern of a living body. With this configuration, biological information such as a finger vein pattern can be obtained as an image inside the living body, and the biometric authentication device that achieves high level of authenticity can be provided.

### Application Example 11

According to an application example 11, an electronic equipment includes the biometric authentication device according to any of the above application examples. With this configuration, biological information such as the vein pattern of the authorized user of the electronic equipment can be captured and pre-registered in the electronic equipment so as to prevent a fraud in authentication and identify the user, and the electronic equipment with a high security can be provided.

### BRIEF DESCRIPTION OF THE DRAWINGS

The invention will be described with reference to the accompanying drawings, wherein like numbers reference like elements.

FIG. 1 is a schematic perspective view which shows a configuration of an imaging device.

FIG. 2 is a schematic sectional view which shows a configuration of the imaging device.

FIG. 3 is a schematic sectional view which shows a configuration of the imaging device.

FIG. 4 is a schematic plan view which shows an arrangement of microlenses of an example 1.

FIGS. 5A to 5D are schematic views which shows a process of forming the microlens of the example 1.

FIG. 6 is a schematic plan view which shows an arrangement of microlenses of an example 2.

FIG. 7 is a schematic plan view which shows a configuration and arrangement of microlenses of an example 3.

FIGS. 8A to 8C are schematic sectional views which shows a process of forming the microlens of the example 3.

FIG. 9 is a block diagram which shows a configuration of a biometric authentication device.

FIG. 10A is a perspective view of a mobile phone as an example of electronic equipment.

FIG. 10B is a schematic view of a personal computer as an example of electronic equipment.

### DESCRIPTION OF EXEMPLARY EMBODIMENTS

Embodiments of the present invention will be described below with reference to the accompanying drawings. For descriptive purpose, parts in the drawings are shown enlarged or reduced in size as appropriate so that they are clearly recognizable.

As used herein, for example, the expression “on the substrate” means that a component is placed on the substrate in contact with its surface, or placed on the substrate with another component interposed therebetween, or partially placed on the substrate in, contact with its surface and partially placed on the substrate with another component interposed therebetween.

### First Embodiment

### Imaging Device

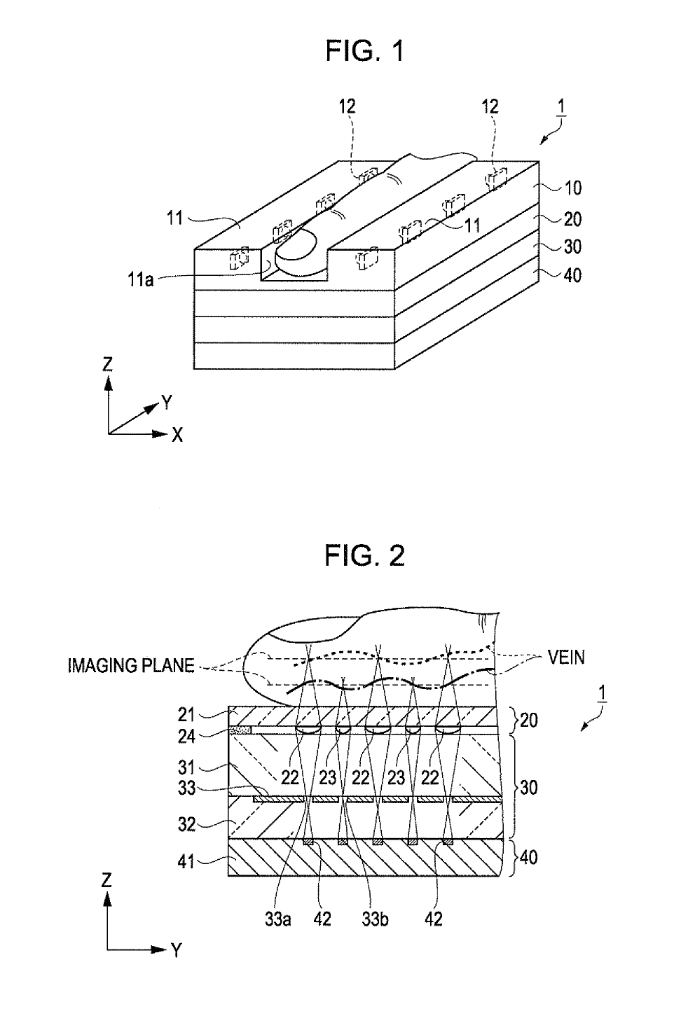

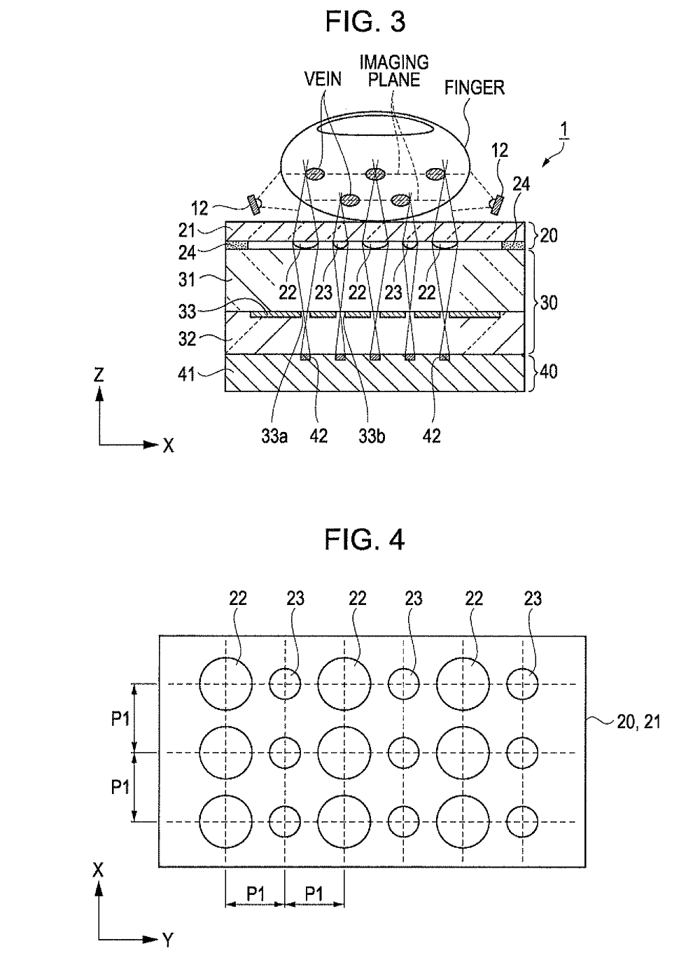

An imaging device according to a first embodiment is a device that captures an image of finger vein pattern as biological information for identifying a living body. First, the imaging device of this embodiment will be described with reference to FIGS. 1 to 3. FIG. 1 is a schematic perspective view which shows a configuration of an imaging device, and FIGS. 2 and 3 are schematic sectional views which show a configuration of the imaging device. FIG. 2 is a sectional view taken in an extending direction of the vein pattern, and FIG. 3 is a sectional view taken in a direction across (perpendicular to) the extending direction of the vein pattern.

As shown in FIG. 1, an imaging device 1 according to this embodiment includes, in sequence, a sensor substrate 40 on which a plurality of imaging elements are disposed, a light shielding substrate 30, a lens array 20 on which a plurality of microlenses as a light converging element are disposed so as to converge a light toward the imaging elements, and a guide substrate 10 on which a finger as a living body is placed.

The guide substrate 10 is made of, for example, a transparent acrylic resin material and includes a recess 11a in which a finger is placed and a pair of guide members 11 disposed on either side of the recess 11a so as to guide the finger to be oriented in a predetermined direction. Light sources 12 that illuminate the finger such as a plurality of LED elements or organic EL elements are positioned inside the guide member 11 in the extending direction of the finger so as to radiate near-infrared light to the finger. The guide substrate 10 is not limited to this configuration, and an identification mark that indicates a finger position, such as a frame, may be provided on a light incident side of the lens array 20 and the light sources 12 may be mounted on or built in the lens array 20. In the following description of the configuration, the extending direction of the finger, that is, the extending direction of the pair of guide members 11 is defined as Y direction, a direction perpendicular to the Y direction is defined as X direction, and a direction in which the substrates are stacked is defined as Z direction. In this embodiment, the Y direction is defined as the extending direction of the vein pattern since the major veins of the finger are located in the extending direction of the finger.

As shown in FIGS. 2 and 3, the sensor substrate 40 includes imaging elements 42 that are disposed on a substrate body 41 spaced apart from each other at predetermined distances and an electric circuit (not shown in the figure) connected to the imaging elements 42. That is, the substrate body 41 may be, for example, a glass epoxy substrate or ceramic substrate that is capable of connecting to an electric circuit and is configured such that the imaging elements 42 can be mounted thereon. The imaging elements 42 may be an optical sensor such as CCD and CMOS. Specifically, an optical sensor that has high sensitivity to near-infrared light can efficiently detect the near-infrared light emitted from the light sources 12 and passed through the finger.

The lens array 20 includes a transparent substrate body 21 and a plurality of microlenses 22 and 23 that are disposed on the substrate body 21 with the convex surfaces of the lenses being oriented toward the imaging elements 42 (in the direction opposite to the light incident side). The microlens 22 is defined as a second microlens of this invention, and the microlens 23 is defined as a first microlens of this invention. The focal distance of the microlens 22 is longer than that of the microlens 23. That is, the microlenses 22 and 23 having different focal distances are provided on the substrate body 21 such that the imaging elements 42 disposed on the sensor substrate 40 receive the light converged by the respective microlenses 22 and 23.

The light shielding substrate 30 is disposed between the lens array 20 and the sensor substrate 40. The light shielding substrate 30 includes a light shielding member 33 that is disposed between two transparent substrates 31 and 32. The light shielding member 33 has openings 33a and 33b. Each opening 33a is formed on the light axis extending between the microlens 22 and the imaging element 42 and each opening 33b is formed on the light axis extending between the microlens 23 and the imaging element 42. The light shielding member 33 is formed of a thin metal plate, such as Cr, that has a light shielding property and whose surface has a low reflectivity of light. The thin metal film is formed and patterned on one of the substrate 31 or 32 such that the openings 33a and 33b are formed in a circular shape in a plan view. The light shielding substrate 30 is formed by bonding the substrates 31 and 32 with the light shielding member 33 interposed therebetween.

The light converged by the microlenses 22 and 23 passes through the corresponding openings 33a and 33b. The openings 33a and 33b are sized so that the light other than that converged by the microlenses 22 and 23, for example stray light such as a scattered light of a light emitted from the light sources 12 and outside light, does not reach the imaging elements 42 therethrough. In particular, since the microlenses 22 and 23 have different focal distances, it is preferable that the openings 33a and 33b are formed in different sizes so that only the flux of light (light flux) that is converged on each of the openings 33a and 33b passes therethrough. That is, the openings 33a and 33b of the light shielding member 33 serve as a diaphragm of the imaging device 1 by which clear image of the vein pattern can be obtained.

Further, the substrate 32 has a thickness such that the light shielding member 33 and the imaging elements 42 are spaced from each other at a constant distance. Specifically, it is preferable that the light fluxes converged by the microlenses 22 and 23 are evenly received on the imaging elements 42 after passing through the respective openings 33a and 33b. Therefore, the thickness of the substrate 32 is defined based on the light receiving surface area of the imaging elements 42 and the focal distances of the microlenses 22 and 23.

Although the substrate 32 of this embodiment is provided for positioning the imaging elements 42 spaced from the light shielding member 33 at a constant distance, the substrate 32 may be eliminated as long as a space between the light shielding member 33 and the imaging elements 42 are adjusted to be at a constant distance.

The lens array 20 is disposed so as to oppose the light shielding substrate 30 with respect to the laminated body composed of the sensor substrate 40 and the light shielding substrate 30, and the convex surfaces (curved surfaces) of the lenses are oriented toward the imaging elements 42. Further, the peripheral area of the lens array 20 is sealed by a sealing agent 24 that contains a gap material so as to keep a space between the light shielding substrate 30 and the substrate body 21 at a constant distance. The sealing agent 24 may be, for example, a heat-curable epoxy adhesive or ultraviolet curable acrylic adhesive.

The light sources 12 emit a light (near-infrared light) toward the finger placed on the lens array 20. The veins inside the finger highly absorb near-infrared light. The light that has passed through the finger as an illuminated object is converged by the microlenses 22 and 23 and received by the imaging elements 42. Since the microlenses 22 and 23 have different focal distances, two imaging planes are located at different positions (heights) in the Z direction inside the finger. The imaging plane of the microlens 22 is located at a deep position in the finger, while the imaging plane of the microlens 23, which has a focal distance shorter than that of the microlens 22, is located at a position near the surface of the finger. In other words, the microlenses 22 and 23 may be formed to have different focal distances so that at least two imaging planes are located at different positions in the z direction inside the finger.

The arrangement and forming process of the above-mentioned microlenses 22 and 23 having different focal distances will be described below by means of examples.

### Example 1

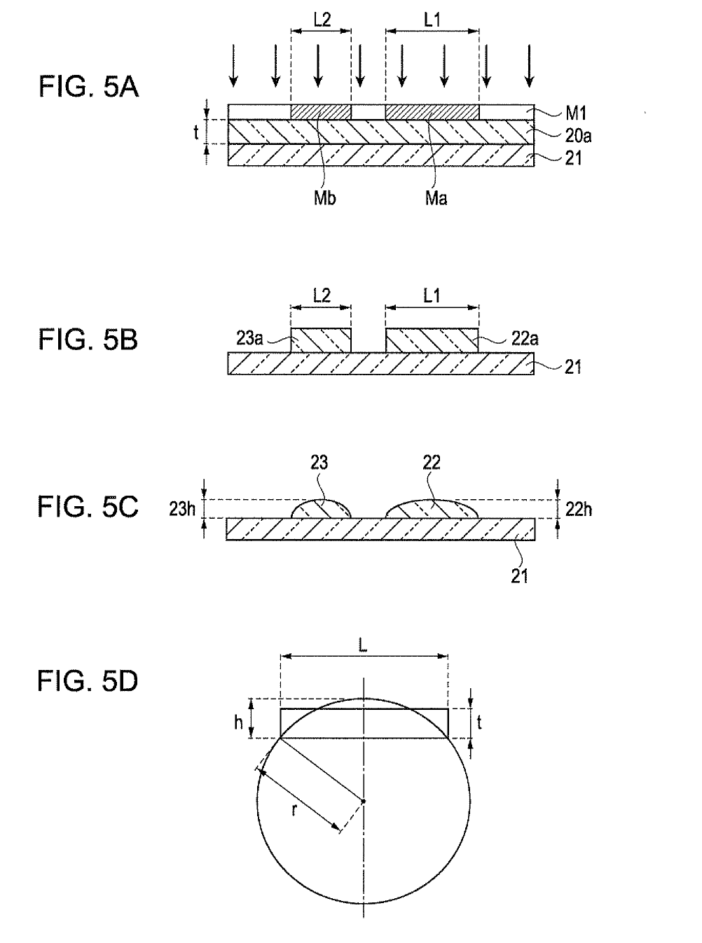

FIG. 4 is a schematic plan view which shows an arrangement of microlenses of an example 1, and FIGS. 5A to 5D are schematic views which show a process of forming the microlens of the example 1.

As shown in FIG. 4, the microlenses 22 and 23 having different focal distances are arranged at an equal pitch P1 in the X direction and the Y direction on the transparent substrate body 21 of the lens array 20 of the example 1. The microlenses 23 are positioned between the microlenses 22 in the Y direction, that is, the direction in which the finger extends. With the above arrangement of the microlenses 22 and 23, the vein patterns of the undulated veins running inside the finger as shown in FIG. 2 can be captured in different imaging planes in the Z direction. For example, when the difference between the focal distances of the microlens 22 and the microlens 23 is 100 μm or more, the vein patterns of the undulated veins in different imaging planes can be captured.

Although varying between individuals, the size of major veins of the finger is approximately 100 μm or less. Accordingly, it is preferable that the microlens 23 that forms the imaging plane near the surface of the finger has a lens diameter in the range of approximately 20 μm or more and 200 μm or less. On the other hand, the microlens 22 that forms the imaging plane at a deep position away from the surface of the finger preferably converge the light from the deep position inside the finger in an efficient manner. Accordingly, the microlens 22 is designed to have the lens diameter larger than that of the microlens 23, specifically, in the range of approximately 150 μm or more and 500 μm or less. The lens diameter is preferably 500 μm or less, since the positioning density of the microlenses 22 per unit surface area is lowered if the lens diameter is larger than 500 μm, leading to a coarse image to be created. Thus, the lens diameter of the microlens 22 having a longer focal distance can be larger than that of the microlens 23 having a shorter focal distance so that a clear image can be captured in spite of the imaging plane being located at a deep position inside the finger.

Although the microlenses 22 and 23 are uniformly arranged in the Y direction in the example 1, the arrangement is not limited thereto. For example, the microlenses 22 and 23 may be alternatively arranged in the X direction and in the Y direction. Further, the intervals between each of the microlenses 22 and 23 may not be necessarily the same in the X direction and in the Y direction, but may be different in the X direction and in the Y direction.

Next, the process of forming the microlenses 22 and 23 (the lens array 20) of the example 1 will be described below with reference to FIG. 5. As shown in FIG. 5A, a photosensitive lens material layer 20a is formed on one side of the transparent substrate body 21 with a constant thickness t (process of forming a photosensitive lens material layer). The process of forming the photosensitive lens material layer 20a includes, for example, applying a solution containing a photosensitive lens material by a spin-coat technique and drying the applied solution. The photosensitive lens material includes a positive-type photosensitive polyimide soluble to organic solvent and photosensitive acrylic material.

Then, the photosensitive lens material layer 20a is exposed to a light via a mask M1 which includes a light shielding pattern Ma having a diameter L1 that corresponds to a lens diameter of the microlens 22 and a light shielding pattern Mb having a diameter L2 that corresponds to a lens diameter of the microlens 23 (exposure process).

Since the photosensitive lens material layer 20a is of a positive-type, the portion exposed to a light is solved in a developer (development process). As shown in FIG. 53, a microlens precursor 22a of a cylindrical shape having the diameter L1 and a microlens precursor 23a of a cylindrical shape having the diameter L2 are formed on the substrate body 21.

The microlens precursors 22a and 23a are heated to be thermally deformed and then cooled into the form of microlens 22 and 23, respectively, each having a convex lens surface as shown in FIG. 5C.

The resultant form of the microlens is determined based on the radius and height of the bottom of the cylindrical microlens precursor prior to heating, specifically, the relationship is expressed by the equations (1) and (2), where L is a diameter and t is a height of the cylindrical microlens precursor, and r is a radius of curvature and h is a height of the microlens after thermal deformation, as shown in FIG. 5D.

The microlens precursor made of a photosensitive lens material and the microlens after thermal deformation have the same volume. Therefore, the following equation (1) is obtained:

π(rh²−h³/3)=π(L/2)²t (1)

Further, since the lens surface after thermal deformation is part of spherical shape, the following equation (2) is obtained:

r2=(R−H)²+(L/2)² (2)

According to the above equations (1) and (2), when t is decreased relative to the lens diameter L, the height h of the lens approaches to a constant value (2t). Here, the curvature of the lens is L²/16t. It is found that the radius of curvature increases as the diameter of the microlens increases. Therefore, the radius of curvature of the microlens 22 is greater than that of the microlens 23, thereby having a longer focal distance.

Further, in the example 1, the height t of the microlens precursors 22a and 23a (that is, a thickness of the photosensitive lens material layer 20a) is adjusted and the diameter of the microlens precursors 22a and 23a is provided so as to obtain a height 22h of the microlens 22 and a height 23h of the microlens 23 having substantially the same value, as shown in FIG. 5C. As a consequence, when the lens array 20 is disposed opposite the light shielding substrate 30 with the sealing agent 24 interposed therebetween, the distance (space) between the substrate body 21 and the light shielding substrate 30 across the area in which the plurality of microlenses 22 and 23 are placed is kept to be constant while the convex lens surfaces of the microlenses 22 and 23 are in contact with the light shielding substrate 30, as shown in FIG. 2.

### Example 2

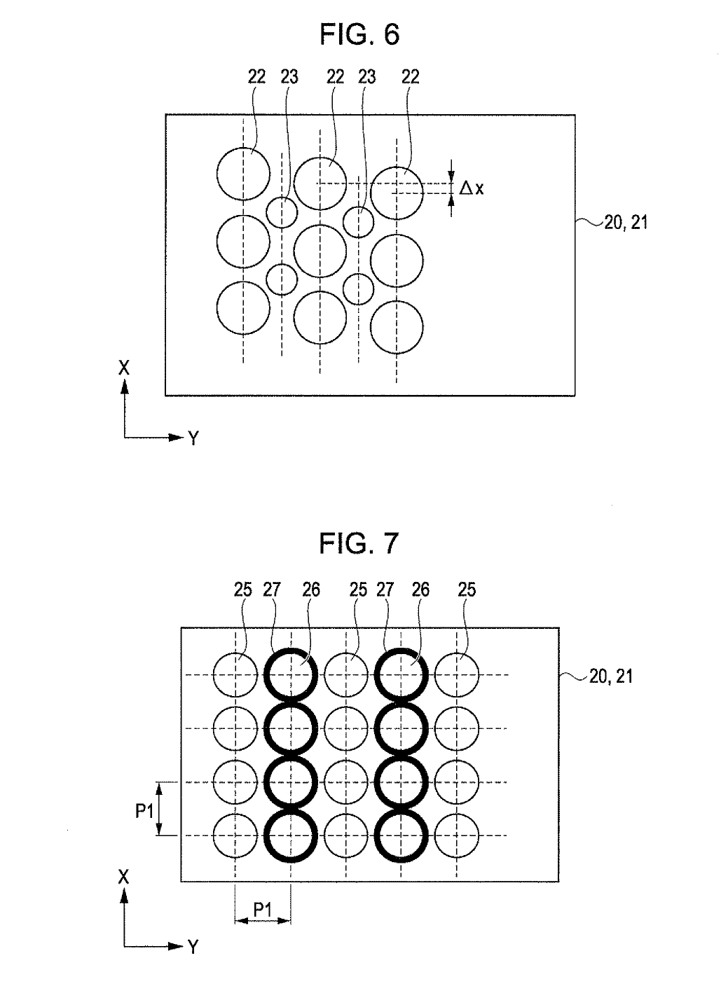

FIG. 6 is a schematic plan view which shows an arrangement of microlenses of an example 2. The example 2 differs from the example 1 in having a different arrangement of the microlenses. Accordingly, the same configuration is indicated by the same reference numeral and is not described further in detail.

As shown in FIG. 6, the microlenses 23 having lens diameters smaller than those of the microlenses 22 are arranged at positions between each of the microlenses 22 in the X direction and the Y direction on the transparent substrate body 21 of the lens array 20. In other words, one microlens 23 having a small lens diameter is surrounded by four microlenses 22 each having a large lens diameter. That is, the positioning density of the microlenses 22 and 23 is greater than that of the example 1. As a result, the space on the substrate body 21 is effectively used so that more microlenses 22 and 23 can be positioned. Further, the microlenses 22 are positioned at equal intervals in the Y direction which is the extending direction of the finger, while slightly offset in the X direction. Here, the amount of offset Δx is preferably 100 μm or less. Since the size of major veins of the finger is approximately 100 μm, the above-mentioned arrangement in which the microlenses 22 and 23 are positioned offset from each other enables imaging of the vein pattern in a more extended area and with a higher accuracy.

### Example 3

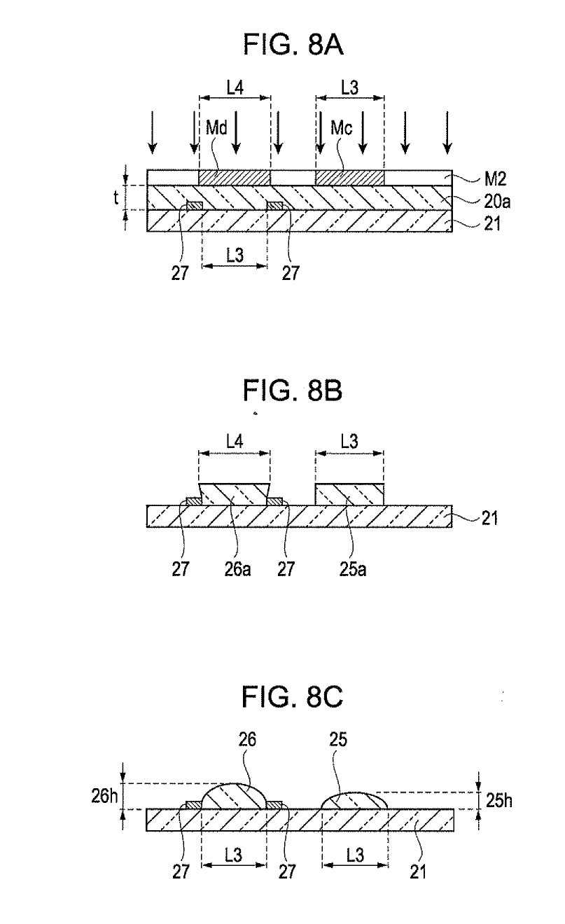

FIG. 7 is a schematic plan view which shows a configuration and arrangement of microlenses of an example 3, and FIGS. 8A to 8C are schematic sectional views which show a process of forming the microlens of the example 3. The example 3 differs from the example 1 and the example 2 in that the microlenses having the same lens diameter and different focal distances are used. Accordingly, the same configuration as that of the example 1 is indicated by the same reference numeral and is not described further in detail.

As shown in FIG. 7, microlenses 25 and 26 having different focal distances are arranged at an equal pitch P1 in the X direction and the Y direction on the transparent substrate body 21 of the lens array 20 of the example 3. The microlenses 25 and 26 have the same lens diameter. The microlens 25 is defined as a second microlens of this invention, while the microlens 26 is defined as a first microlens of this invention. The focal distance of the microlens 25 is longer than that of the microlens 26. Further, as described later in detail, a reflection member 27 in a ring shape is disposed on the substrate body 21 along the outer periphery of the microlens 26 so as to reflect a light.

With the above arrangement of the microlenses 25 and 26, similarly to the example 1, the vein patterns of the undulated veins running inside the finger can be captured in different imaging planes in the Z direction.

Next, the process of forming the microlenses 25 and 26 will be described below with reference to FIG. 8. As shown in FIG. 8A, the reflection members 27 of a ring shape having the same inner diameter as that of the lens diameter L3 are formed on one side of the substrate body 21. The process of forming the reflection member 27 includes forming a film of metal having a light reflectivity, such as aluminum and silver, so as to cover the surface of the substrate body 21 and patterning the film to form the reflection member 27 in a ring shape. As a matter of course, the reflection members 27 are formed at positions corresponding to the microlenses 26 which are subsequently formed (process of forming a reflection member).

Then, the photosensitive lens material layer 20a is formed so as to cover the reflection member 27 (process of forming a photosensitive lens material layer). The process of forming the photosensitive lens material layer 20a is the same as described in the example 1.

Then, the photosensitive lens material layer 20a is exposed to a light via a mask M2 which includes a light shielding pattern Mc having the same diameter as a lens diameter L3 of the microlens 25 and a light shielding pattern Md having a diameter L4 that is slightly larger than the lens diameter L3 (exposure process). Further, a portion of the photosensitive lens material layer 20a which is at the inner side of the light shielding pattern Md is also exposed to the light, since the light transmitted through the mask M2 is partially reflected by the reflection member 27.

As shown in FIG. 8B, when the exposed photosensitive lens material layer 20a is developed, a microlens precursor 25a of a cylindrical shape having the diameter L3 and a microlens precursor 26a in a shape of inverted truncated cone are formed on the substrate body 21. The microlens precursor 26a has the top whose diameter is larger than the diameter of the bottom which is on the substrate body 21. The microlens precursor 26a is formed to have the volume larger than that of the microlens precursor 25a. Accordingly, as shown in FIG. 8C, when the microlens precursors 25a and 26a are heated to be thermally deformed and then cooled, the microlenses 25 and 26 are formed with different heights of the lens surface, as derived from the aforementioned equations (1) and (2). A height 26h of the microlens 26 is greater (higher) than a height 25h of the microlens 25.

Since the microlenses 25 and 26 have the same lens diameter L3, the radius of curvature r of the microlens 26 is smaller than that of the microlens 25. That is, the focal distance of the microlens 25 is longer than that of the microlens 26. In other words, the focal distance of the microlens 26 is shorter than that of the microlens 25.

According to the aforementioned first embodiment, the following effects can be obtained:

(1) The imaging device 1 is a device that captures a vein pattern of a finger as a living body and includes the lens array 20 that is provided with microlenses 22 and 23 (or microlenses 25 and 26) disposed on the transparent the substrate body 21. The microlenses 22 and 23 (or microlenses 25 and 26) have different focal distances and converge the light that has passed through the finger which is illuminated by the light sources 12. As a result, the vein patterns corresponding to two imaging planes inside the finger can be captured. Therefore, a greater amount of information of vein pattern can be obtained, when compared with the case where the microlenses have the same focal distance.
(2) The light shielding substrate 30 is disposed between the lens array 20 and the sensor substrate 40 that includes the imaging elements 42 and includes the light shielding member 33 that has the openings 33a and 33b, which correspond to the microlenses 22 and 23, respectively, having different focal distances. Therefore, clear images of the vein pattern can be captured.
(3) The lens diameter of the microlenses 22 having a longer focal distance is larger than that of the microlenses 23, thereby effectively converging the light, so that the pattern of veins deep inside the finger can be clearly imaged.
(4) According to the example 2, since the microlenses 22 and 23 having different focal distances and lens diameters are effectively positioned in a plane on the substrate body 21, the vein pattern can be captured with high accuracy.
(5) According to the example 3, since the microlenses 25 and 26 having different focal distances have the same lens diameter, the arrangement of microlenses 25 and 26 does not have many constraints in design and the positioning of microlenses 25 and 26 can be determined with ease.

### Second Embodiment

### Biometric Authentication Device

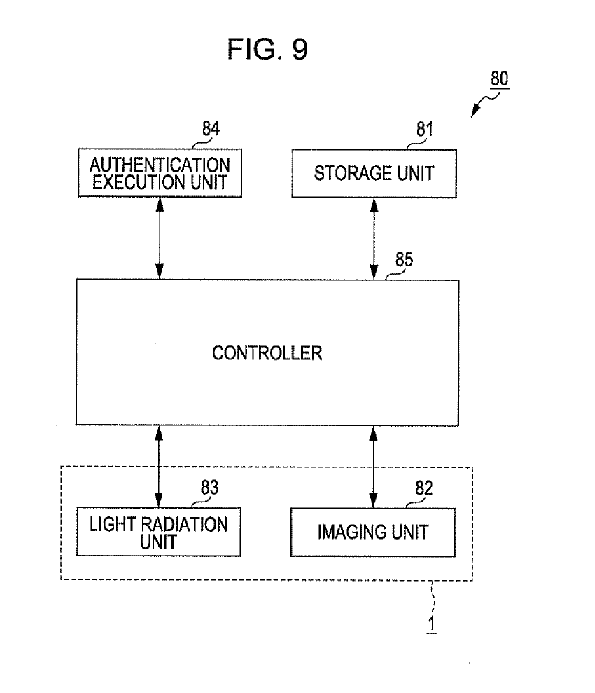

An example of a biometric authentication device which includes the imaging device 1 of the first embodiment will be described below with reference to FIG. 9. FIG. 9 is a block diagram which shows a configuration of a biometric authentication device.

As shown in FIG. 9, a biometric authentication device 80 of this embodiment includes a storage unit 81, an imaging unit 82, a light radiation unit 83 an authentication execution unit 84 and a controller 85 that controls those units. The imaging unit 82 and the light radiation unit 83 correspond to the imaging device 1, the imaging unit 82 corresponds to the guide substrate 10, the lens array 20, the light shielding substrate 30 and the sensor substrate 40, and the light radiation unit 83 corresponds to the light source 12.

The light radiation unit 83 radiates a light (near-infrared light) toward the finger in response to signals transmitted from the controller 85. The imaging unit 82 initiates imaging operation in response to control signals transmitted from the controller 85 and outputs the captured vein pattern to the controller 85.

The controller 85 executes various processes such as arithmetic processing of the signals and signal transmission based on the program stored in the storage unit 81, and transmits the vein pattern which is output from the imaging unit 82 to the authentication execution unit 84.

The storage unit 81 is a memory device such as a hard disk and semiconductor memory (DRAM (Dynamic Random Access Memory), or SRAM (Static Random Access Memory)). The storage unit 81 stores various information such as a program for biometric authentication, a program for image construction, pre-registered vein patterns for use in authentication and the log of authentication.

When the vein pattern (image information) is captured by the imaging unit 82 and output to the authentication execution unit 84, the authentication execution unit 84 verifies whether the captured vein pattern matches the pre-registered vein pattern (image information) of the living body. The procedures of vein authentication vary depending on the techniques to check the similarity of the vein patterns.

Since the biometric authentication device 80 includes the imaging device 1 of the first embodiment, the vein pattern inside the finger (biological information) in at least two imaging planes can be obtained. The authentication execution unit 84 can verify whether the captured vein pattern matches the pre-registered vein pattern for each of the two imaging planes by checking the similarity of those vein patterns. Therefore, the authenticity can be verified with higher accuracy compared with the case where the authentication is executed by using only one registered vein pattern.

Alternatively, the vein pattern may be obtained as a stereoscopic image by synthesizing the images of vein pattern captured for each of the imaging planes. With this configuration, the authentication with improved accuracy can be achieved by preventing forgery.

### Third Embodiment

### Electronic Equipment

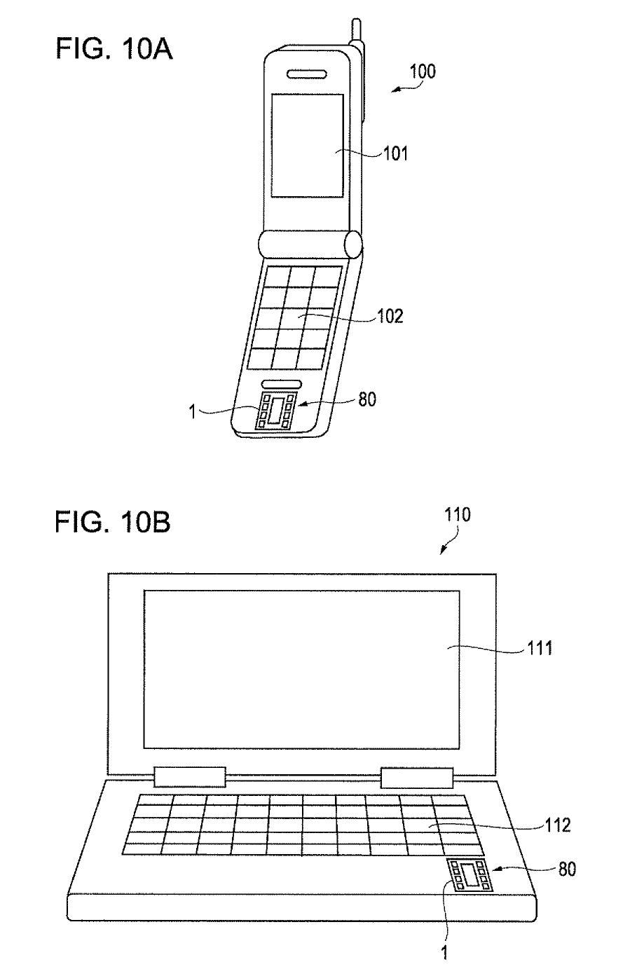

An electronic equipment according to a third embodiment will be described below with reference to FIG. 10. FIG. 10A is a perspective view of a mobile phone as an example of electronic equipment, and FIG. 10B is a schematic view of a personal computer as an example of electronic equipment.

As shown in FIG. 10A, a mobile phone 100 as an example of electronic equipment of this embodiment includes a display 101, operation buttons 102 and a biometric authentication device 80. An imaging device 1 is mounted in the main body of the mobile phone 100 so that the vein pattern of the finger is captured by placing the finger thereon. The biometric authentication device 80 can use the captured vein pattern, for example, to unlock the mobile phone 100 or execute personal authentication for financial transaction.

As shown in FIG. 10B, a notebook personal computer 110 as an example of electronic equipment of this embodiment includes a display 111, input buttons 112 and a biometric authentication device 80. An imaging device 1 is mounted in the main body of the personal computer 110 so that the vein pattern of the finger is captured by placing the finger thereon. The biometric authentication device 80 can use the captured vein pattern, for example, to log in the personal computer 110 or execute personal authentication for financial transaction.

Since the above-mentioned mobile phone 100 and personal computer 110 include the biometric authentication device 80 having the imaging device 1 that is usable both indoor and outdoor to capture image of the vein pattern, it is possible to perform personal authentication with high accuracy under any environment, thereby preventing occurrences of fraud.

it should be noted that the technical scope of the invention is not limited to the above embodiments and various modifications can be made to the above embodiments without departing from the spirit of the invention. That is, specific materials and configurations described in the above embodiments are for exemplary purposes only and various modifications can be made as appropriate.

In addition to the above embodiments, various modified examples are possible as will be described below.

### Modified Example 1

The arrangement of microlenses of the lens array 20 is not limited to those described in the above examples 1 to 3. For example, although the microlenses having two different focal distances are used in the above examples, the microlenses having three or more different focal distances may be used. Further, the adjacent microlenses in the example 1 may be arranged so as to be in contact with each other in the X direction or in the Y direction on the substrate body 21.

### Modified Example 2

The lens array 20 may include the plurality of microlenses 22 and 23 that are disposed with the convex surfaces of the lenses being oriented toward the incident light (in the direction opposite to the imaging elements 42).

### Modified Example 3

The blood vessels in the imaging planes to be captured by the microlenses 22 and 23, which have different focal distances, are not limited to veins. For example, the focal distances of the microlenses 22 and 23 may be adjusted for arteries so that the authentication can be executed by using a combination of vein pattern and arterial pattern or a combination of arterial patterns of different imaging planes.

### Modified Example 4

The light sources 12 of the imaging device 1 may not be necessarily positioned along both sides of the finger. For example, the light sources 12 may be positioned at both ends in the extending direction of the finger. This enables the imaging device 1 to be reduced in size.

### Modified Example 5

The process of forming the microlenses of the lens array 20 having different focal distances is not limited to the use of photosensitive lens material. For example, the microlenses may be made of a resin lens material having high refractive index and formed by using a metal molding.

### Modified Example 6

The electronic equipment which includes the biometric authentication device 80 having the imaging device 1 is not limited to the mobile phone 100 or the personal computer 110 of the third embodiment. For example, the biometric authentication device 80 may be incorporated into mobile terminals such as PDA or POS so as to be used for broader purposes while ensuring high security.

What is claimed is:

1. An imaging device that captures a vein pattern of a living body, the imaging device comprising:
a transparent substrate;
a lens array including a plurality of microlenses that are arranged two dimensionally with respect to the transparent substrate; and
an imaging element that receives light converged by the lens array, the plurality of microlenses including a plurality of first microlenses and a plurality of second microlenses, the plurality of second microlenses having a focal distance longer than that of the plurality of first microlenses.

2. The imaging device according to claim 1, a lens diameter of the plurality of second microlenses being larger than a lens diameter of the plurality of first microlenses.

3. The imaging device according to claim 2, the plurality of second microlenses being positioned in a predetermined direction at predetermined intervals, and one first microlens of the plurality of first microlenses being positioned between two second microlenses of the plurality of second microlenses.

4. The imaging device according to claim 3, the plurality of second microlenses being positioned to be offset from each other in a direction intersecting with the predetermined direction.

5. The imaging device according to claim 4, an offset amount of the plurality of second microlenses in the direction intersecting with the predetermined direction being 100 μm or less.

6. The imaging device according to claim 2, one first microlens of the plurality of first microlenses being surrounded by four second microlenses of the plurality of second microlenses, the four second microlenses being positioned in a predetermined direction and a direction intersecting with the predetermined direction.

7. The imaging device according to claim 2, the lens diameter of the plurality of first microlenses being between 20 μm and 200 μm.

8. The imaging device according to claim 2, the lens diameter of the plurality of second microlenses being between 150 μm and 500 μm.

9. The imaging device according to claim 1, a lens diameter of the plurality of first microlenses being the same as a lens diameter of the plurality of second microlenses, and the first and second microlenses being alternately positioned in a predetermined direction.

10. The imaging device according to claim 1, the plurality of first microlenses and the plurality of second microlenses are alternately positioned in a predetermined direction and a direction intersecting with the predetermined direction.

11. The imaging device according to claim 1, further comprising:
a light shielding member having openings formed at positions between the lens array and the imaging elements on light axes of the plurality of first microlenses and the plurality of second microlenses, the size of an opening with respect to one of the plurality of first microlenses and the size of an opening with respect to one of the plurality of second microlenses being different.

12. A biometric authentication device comprising:
the imaging device according to claim 1; and
an authentication execution unit that verifies whether the vein pattern captured by the imaging device matches a pre-registered vein pattern of a living body.

13. A biometric authentication device comprising:
the imaging device according to claim 2; and
an authentication execution unit that verifies whether the vein pattern captured by the imaging device matches a pre-registered vein pattern of a living body.

14. A biometric authentication device comprising:
the imaging device according to claim 3; and
an authentication execution unit that verifies whether the vein pattern captured by the imaging device matches a pre-registered vein pattern of a living body.

15. A biometric authentication device comprising:
the imaging device according to claim 4; and
an authentication execution unit that verifies whether the vein pattern captured by the imaging device matches a pre-registered vein pattern of a living body.

16. A biometric authentication device comprising:
the imaging device according to claim 5; and
an authentication execution unit that verifies whether the vein pattern captured by the imaging device matches a pre-registered vein pattern of a living body.

17. An electronic equipment comprising the biometric authentication device according to claim 12.

18. An electronic equipment comprising the biometric authentication device according to claim 13.

19. An electronic equipment comprising the biometric authentication device according to claim 14.

20. An electronic equipment comprising the biometric authentication device according to claim 15.

21. An imaging device that captures a vein pattern of a living body, the imaging device comprising:
a lens array including a plurality of microlenses; and
an imaging element that receives light converged by the lens array, the plurality of microlenses including
a plurality of first microlenses with a first height and
a plurality of second microlenses with a second height,
the first height being greater than the second height, and a lens diameter of the plurality of first microlenses being the same as a lens diameter of the plurality of second microlenses.

22. The imaging device according to claim 21, the plurality of second microlenses having a focal distance longer than that of the plurality of first microlenses.

23. The imaging device according to claim 22, one first microlens of the plurality of first microlenses being surrounded by four second microlenses of the plurality of second microlenses, the four second microlenses being positioned in a predetermined direction and a direction intersecting with the predetermined direction.

24. The imaging device according to claim 23, the plurality of second microlenses being positioned to be offset from each other in the direction intersecting with the predetermined direction.

25. The imaging device according to claim 24, an offset amount of the plurality of second microlenses in the direction intersecting with the predetermined direction being 100 μm or less.

26. The imaging device according to claim 21, further comprising:
a light shielding member having openings formed at positions between the lens array and the imaging elements on light axes of the plurality of first microlenses and the plurality of second microlenses, the size of an opening with respect to one of the plurality of first microlenses and the size of an opening with respect to one of the plurality of second microlenses being different.

27. An imaging device that captures a vein pattern of a living body, the imaging device comprising:
a transparent substrate;
a lens array including a plurality of microlenses that are arranged two dimensionally with respect to the transparent substrate; and
an imaging element that receives light converged by the lens array, the plurality of microlenses including
a plurality of first microlenses structured to image the vein pattern of a first plane of the living body, and
a plurality of second microlenses structured to image the vein pattern of a second plane of the living body, the first plane being different from the second plane.

28. The imaging device according to claim 27, the first plane being located closer to the transparent substrate than the second plane.

29. The imaging device according to claim 27, the plurality of second microlenses having a focal distance longer than that of the plurality of first microlenses.

30. The imaging device according to claim 29, a lens diameter of the plurality of second microlenses being larger than a lens diameter of the plurality of first microlenses.

31. The imaging device according to claim 29, the plurality of first microlenses having a first height and the plurality of second microlenses having a second height, the first height being greater than the second height.
